(19) United States
(12) Patent Application Publication
(10) Pub. No.: US 2023/0392954 A1
(43) Pub. Date: Dec. 7, 2023

(54) VEHICLE SYSTEMS AND RELATED MESSAGE PRIORITIZATION METHODS

(71) Applicant: HONEYWELL INTERNATIONAL INC., Charlotte, NC (US)

(72) Inventors: Sujaya Rao, Bangalore (IN); Priyanshu Sinha, Bengaluru (IN); Satyanarayan Kar, Bangalore (IN)

(73) Assignee: HONEYWELL INTERNATIONAL INC., Charlotte, NC (US)

(21) Appl. No.: 17/814,701

(22) Filed: Jul. 25, 2022

(30) Foreign Application Priority Data
Jun. 6, 2022 (IN) 202211032277

(51) Int. Cl. G01C 23/00; G06F 40/30; G08G 5/00; B64D 43/00

(52) U.S. Cl. CPC G01C 23/005; G06F 40/30; G08G 5/0021; B64D 43/00; G08G 5/003

(57) ABSTRACT

Methods and systems are provided for assisting operation of a vehicle by intelligently prioritizing messages relevant to a route for the vehicle. One method involves analyzing textual content of the message to automatically identify values for a plurality of fields of information specified by the message and obtaining current values for one or more of those fields from one or more data sources associated with the vehicle. In response to identifying a difference between a specified value and the corresponding current value for a field of information, the method automatically assigns a priority level to the message based at least in part on the difference and provides graphical indicia of the priority level assigned to the message and the specified value for the field.

### CROSS REFERENCE TO RELATED APPLICATION

This application claims priority to India Provisional Patent Application No. 202211032277, filed Jun. 6, 2022, the entire content of which is incorporated by reference herein.

### TECHNICAL FIELD

The subject matter described herein relates generally to vehicle systems, and more particularly, embodiments of the subject matter relate to avionics systems and methods for intelligent, contextual management of messages such as notices to airmen (NOTAMs).

### BACKGROUND

Air traffic control typically involves voice communications between air traffic control and a pilot or crewmember onboard the various aircrafts within a controlled airspace. For example, an air traffic controller (ATC) may communicate an instruction or a request for pilot action by a particular aircraft using a call sign assigned to that aircraft. In addition to audio communications with ATC, aircraft may also receive alerts, advisories, notices, instructions, such as notices to airmen (NOTAMs), pilot reports (PIREPs) or the like, or receive clearance communications or other messages from various other sources, such as, for example, a controller-pilot datalink (CPDLC) system, an automatic terminal information service (ATIS), an aircraft communications addressing and reporting system (ACARS), and the like. Often, the content of such messages includes unstructured text or data that can be difficult to quickly review and comprehend what information is relevant. Moreover, the volume of such messages and the diversity of data or information contained therein further increases the burden on the pilot or other user to ascertain the relevant information. For example, a typical briefing package for a pilot may include tens (and in some cases more than one hundred) of pages of NOTAMs related to a planned flight.

Accordingly, it is desirable to provide aircraft systems and methods that reduce head-down time (HDT) and facilitate a pilot maintaining situational awareness while improving comprehension and adherence to information contained in messages or other communications to improve safety and efficiency of operation. Other desirable features and characteristics of the methods and systems will become apparent from the subsequent detailed description and the appended claims, taken in conjunction with the accompanying drawings and the preceding background.

### BRIEF SUMMARY

Methods and systems are provided for assisting operation of a vehicle, such as an aircraft. One method of assisting operation of a vehicle involves obtaining a message relevant to a route for the vehicle, analyzing textual content of the message to automatically identify values for a plurality of fields of information and obtaining current values for one or more fields of the plurality of fields from one or more data sources associated with the vehicle. In response to identifying a difference between at least one of the values for the one or more fields of the plurality of fields and at least one of the current values for the one or more fields of the plurality of fields, the method continues by automatically assigning a priority level to the message based at least in part on the difference and providing graphical indicia of the priority level assigned to the message and the at least one of the values for the plurality of fields.

In another embodiment, a computer-readable medium having computer-executable instructions stored thereon is provided. The computer-executable instructions, when executed by a processing system, cause the processing system to obtain a message relevant to a route for a vehicle, analyze textual content of the message to automatically identify values for a plurality of fields of information, obtain current values for one or more fields of the plurality of fields from one or more data sources associated with the vehicle, and in response to a difference between at least one of the values for the one or more fields of the plurality of fields and at least one of the current values for the one or more fields of the plurality of fields, automatically assign a priority level to the message based at least in part on the difference and provide graphical indicia of the priority level assigned to the message and the at least one of the values for the plurality of fields.

In another embodiment, a system is provided that includes a display device, an onboard system to provide a current value for a field of information relating to a route for a vehicle, a data storage element to maintain a prioritization model, and a processing system coupled to the display device, the onboard system and the data storage element to obtain a message relevant to the route for the vehicle, analyze textual content of the message to automatically identify a specified value for the field of information, and in response to a difference between the current value and the specified value, automatically assign a priority level to the message based at least in part on the difference using the prioritization model and provide graphical indicia of the priority level assigned to the message and the specified value on the display device.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

Embodiments of the subject matter will hereinafter be described in conjunction with the following drawing figures, wherein like numerals denote like elements, and:

FIG. 1 is a block diagram illustrating a system suitable for use with a vehicle such as an aircraft in accordance with one or more exemplary embodiments;

FIG. 2 is a block diagram illustrating a message prioritization system suitable for use with the aircraft system of FIG. 1 in accordance with one or more exemplary embodiments;

FIG. 3 is a block diagram illustrating a message analysis service 300 suitable for use in the message prioritization system of FIG. 2 in accordance with one or more exemplary embodiments;

FIGS. 4-6 depict exemplary sequences of graphical user interface (GUI) displays suitable for presentation by a message analysis service on a display device in the system of FIG. 1 or FIG. 2 in accordance with one or more exemplary embodiments; and

FIG. 7 is a flow diagram of a message prioritization process suitable for implementation by the message prioritization system of FIG. 2 in the aircraft system of FIG. 1 in accordance with one or more exemplary embodiments.

### DETAILED DESCRIPTION

The following detailed description is merely exemplary in nature and is not intended to limit the subject matter of the application and uses thereof. Furthermore, there is no intention to be bound by any theory presented in the preceding background, brief summary, or the following detailed description.

Embodiments of the subject matter described herein generally relate to systems and methods for intelligently analyzing and prioritizing messages related to vehicle operation in a context-sensitive manner to improve comprehension and actionability. For purposes of explanation, the subject matter is primarily described herein in the context of analyzing messages relevant to a flight plan (or planned flight path) for an aircraft; however, the subject matter described herein is not necessarily limited to aircraft or avionic environments, and in alternative embodiments, may be implemented in an equivalent manner for ground operations, marine operations, or otherwise in the context of other types of vehicles with respect to a planned route of travel.

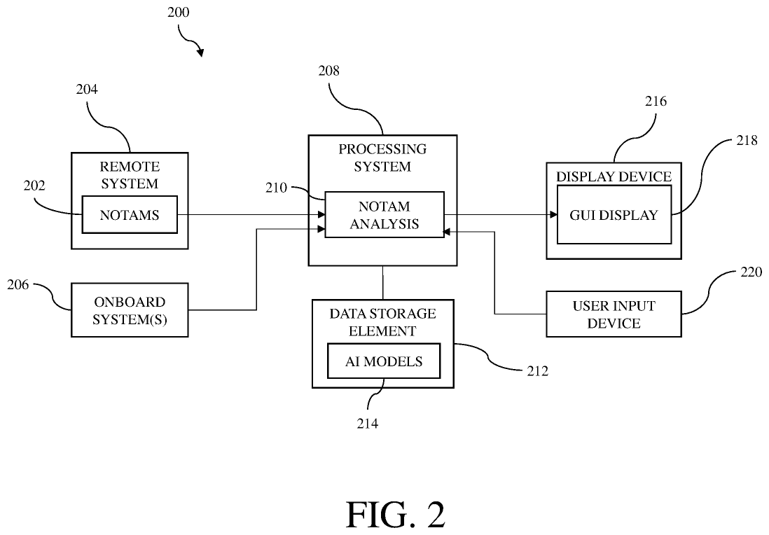

As described in greater detail below primarily in the context of FIGS. 2-7, the textual content of messages relevant to the planned flight path (or route) for an aircraft are analyzed using natural language processing (NLP), parts of speech tagging or other semantic or syntactic techniques to ascertain the intent, objective or semantic significance of a respective message and identify specified values for different fields of information contained within a respective message. Current values (or currently planned values) for those fields of information relating to the current flight plan are obtained from onboard systems or other data sources associated with the aircraft and compared to the specified values for those fields from the message(s) pertaining to the current flight plan. In response to identifying a discrepancy or difference between the specified value for a particular field of information and the current value for that field, the message is automatically assigned a priority level or score utilized to intelligently present messages in accordance with the respective priorities associated therewith. In exemplary embodiments, one or more recommended actions responsive to a particular message are also automatically determined and provided to the pilot or other user in concert with depicting the respective message, thereby facilitating the pilot or other user responding to the discrepancy between the specified value associated with the respective message and the current or planned value.

In one or more exemplary embodiments, the subject matter described herein is implemented in the context of notice to airmen (NOTAM) messages and utilizes artificial intelligence (AI) to determine the intent of a particular NOTAM and prioritize the respective NOTAM based on the intent of the NOTAM, the discrepancy between a specified value for a particular field contained within the NOTAM and the current value for that field, and the current operational context or status of the aircraft (e.g., the current flight plan, the current flight phase, the current altitude, the current aircraft configuration, the current meteorological conditions and/or the like). In this regard, the subject matter described herein is capable of intelligently classifying or sorting the NOTAMs into different priority levels or classifications based on the relationship between the textual content and intent of the respective NOTAM and the current flight plan and current operational context of the aircraft. Thus, higher priority NOTAMs may be preferentially displayed or identified, thereby reducing head-down time (HDT) and alleviating the pilot of the manual burden of reviewing a comprehensive set of NOTAMs to manually ascertain what NOTAMs are most operationally significant. In exemplary embodiments, AI techniques are also utilized to analyze the intent and content of the NOTAM in relation to the current flight plan and current operational context of the aircraft to intelligently recommend one or more actions that may be initiated or otherwise performed by a pilot or other user in response to a discrepancy between a specified value in a NOTAM and a current value associated with the current flight plan and/or current state of the aircraft. Thus, in addition to alleviating the pilot of the manual burden of identifying what NOTAMs are relevant or operationally significant, the subject matter described herein may also alleviate the cognitive burden of determining how to best respond to an operationally significant NOTAM, thereby improving safety and efficiency of operation.

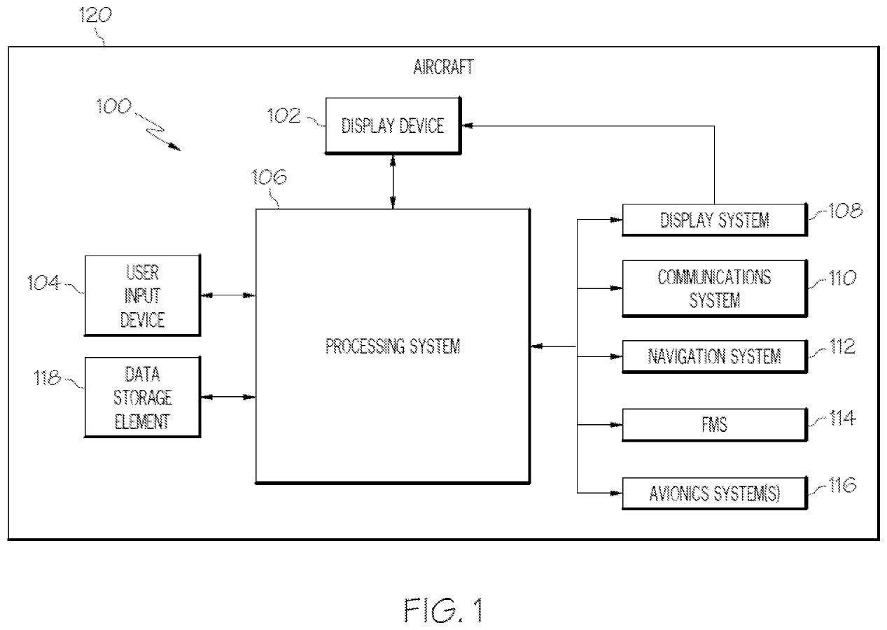

FIG. 1 depicts an exemplary embodiment of a system 100 which may be utilized with a vehicle, such as an aircraft 120. In an exemplary embodiment, the system 100 includes, without limitation, a display device 102, one or more user input devices 104, a processing system 106, a display system 108, a communications system 110, a navigation system 112, a flight management system (FMS) 114, one or more avionics systems 116, and a data storage element 118 suitably configured to support operation of the system 100, as described in greater detail below.

In exemplary embodiments, the display device 102 is realized as an electronic display capable of graphically displaying flight information or other data associated with operation of the aircraft 120 under control of the display system 108 and/or processing system 106. In this regard, the display device 102 is coupled to the display system 108 and the processing system 106, and the processing system 106 and the display system 108 are cooperatively configured to display, render, or otherwise convey one or more graphical representations or images associated with operation of the aircraft 120 on the display device 102. The user input device 104 is coupled to the processing system 106, and the user input device 104 and the processing system 106 are cooperatively configured to allow a user (e.g., a pilot, co-pilot, or crew member) to interact with the display device 102 and/or other elements of the system 100, as described in greater detail below. Depending on the embodiment, the user input device(s) 104 may be realized as a keypad, touchpad, keyboard, mouse, touch panel (or touchscreen), joystick, knob, line select key or another suitable device adapted to receive input from a user. In some exemplary embodiments, the user input device 104 includes or is realized as an audio input device, such as a microphone, audio transducer, audio sensor, or the like, that is adapted to allow a user to provide audio input to the system 100 in a “hands free” manner using speech recognition.

The processing system 106 generally represents the hardware, software, and/or firmware components configured to facilitate communications and/or interaction between the elements of the system 100 and perform additional tasks and/or functions to support operation of the system 100, as described in greater detail below. Depending on the embodiment, the processing system 106 may be implemented or realized with a general purpose processor, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. The processing system 106 may also be implemented as a combination of computing devices, e.g., a plurality of processing cores, a combination of a digital signal processor and a microprocessor, a plurality of microprocessors, one or more microprocessors in conjunction with a digital signal processor core, or any other such configuration. In practice, the processing system 106 includes processing logic that may be configured to carry out the functions, techniques, and processing tasks associated with the operation of the system 100, as described in greater detail below. Furthermore, the steps of a method or algorithm described in connection with the embodiments disclosed herein may be embodied directly in hardware, in firmware, in a software module executed by the processing system 106, or in any practical combination thereof. For example, in one or more embodiments, the processing system 106 includes or otherwise accesses a data storage element (or memory), which may be realized as any sort of non-transitory short or long term storage media capable of storing programming instructions for execution by the processing system 106. The code or other computer-executable programming instructions, when read and executed by the processing system 106, cause the processing system 106 to support or otherwise perform certain tasks, operations, functions, and/or processes described herein.

The display system 108 generally represents the hardware, software, and/or firmware components configured to control the display and/or rendering of one or more navigational maps and/or other displays pertaining to operation of the aircraft 120 and/or onboard systems 110, 112, 114, 116 on the display device 102. In this regard, the display system 108 may access or include one or more databases suitably configured to support operations of the display system 108, such as, for example, a terrain database, an obstacle database, a navigational database, a geopolitical database, an airport database, a terminal airspace database, a special use airspace database, or other information for rendering and/or displaying navigational maps and/or other content on the display device 102.

Still referring to FIG. 1, in exemplary embodiments, the processing system 106 is also coupled to the navigation system 112, which is configured to provide real-time navigational data and/or information regarding operation of the aircraft 120. The navigation system 112 may be realized as a global positioning system (GPS), inertial reference system (IRS), or a radio-based navigation system (e.g., VHF omni-directional radio range (VOR) or long range aid to navigation (LORAN)), and may include one or more navigational radios or other sensors suitably configured to support operation of the navigation system 112, as will be appreciated in the art. The navigation system 112 is capable of obtaining and/or determining the instantaneous position of the aircraft 120, that is, the current (or instantaneous) location of the aircraft 120 (e.g., the current latitude and longitude) and the current (or instantaneous) altitude or above ground level for the aircraft 120. The navigation system 112 is also capable of obtaining or otherwise determining the heading of the aircraft 120 (i.e., the direction the aircraft is traveling in relative to some reference). In the illustrated embodiment, the processing system 106 is also coupled to the communications system 110, which is configured to support communications to and/or from the aircraft 120. For example, the communications system 110 may support communications between the aircraft 120 and air traffic control or another suitable command center or ground location. In this regard, the communications system 110 may be realized using a radio communication system and/or another suitable data link system.

In exemplary embodiments, the processing system 106 is also coupled to the FMS 114, which is coupled to the navigation system 112, the communications system 110, and one or more additional avionics systems 116 to support navigation, flight planning, and other aircraft control functions in a conventional manner, as well as to provide real-time data and/or information regarding the operational status of the aircraft 120 to the processing system 106. Although FIG. 1 depicts a single avionics system 116, in practice, the system 100 and/or aircraft 120 will likely include numerous avionics systems for obtaining and/or providing real-time flight-related information that may be displayed on the display device 102 or otherwise provided to a user (e.g., a pilot, a co-pilot, or crew member). For example, practical embodiments of the system 100 and/or aircraft 120 will likely include one or more of the following avionics systems suitably configured to support operation of the aircraft 120: a weather system, an air traffic management system, a radar system, a traffic avoidance system, an autopilot system, an autothrust system, a flight control system, hydraulics systems, pneumatics systems, environmental systems, electrical systems, engine systems, trim systems, lighting systems, crew alerting systems, electronic checklist systems, an electronic flight bag and/or another suitable avionics system.

In the illustrated embodiment, the aircraft system 100 includes a data storage element 118, which is capable of storing, maintaining or otherwise implementing one or more of the databases that support operations of the aircraft system 100 described herein. In some embodiments, the data storage element 118 contains aircraft procedure information (or instrument procedure information) for a plurality of airports and maintains association between the aircraft procedure information and the corresponding airports. Depending on the embodiment, the data storage element 118 may be physically realized using RAM memory, ROM memory, flash memory, registers, a hard disk, or another suitable data storage medium known in the art or any suitable combination thereof. As used herein, aircraft procedure information should be understood as a set of operating parameters, constraints, or instructions associated with a particular aircraft action (e.g., approach, departure, arrival, climbing, and the like) that may be undertaken by the aircraft 120 at or in the vicinity of a particular airport. An airport should be understood as referring to any sort of location suitable for landing (or arrival) and/or takeoff (or departure) of an aircraft, such as, for example, airports, runways, landing strips, and other suitable landing and/or departure locations, and an aircraft action should be understood as referring to an approach (or landing), an arrival, a departure (or takeoff), an ascent, taxiing, or another aircraft action having associated aircraft procedure information. An airport may have one or more predefined aircraft procedures associated therewith, wherein the aircraft procedure information for each aircraft procedure at each respective airport are maintained by the data storage element 118 in association with one another.

Depending on the embodiment, the aircraft procedure information may be provided by or otherwise obtained from a governmental or regulatory organization, such as, for example, the Federal Aviation Administration (FAA) in the United States. In an exemplary embodiment, the aircraft procedure information comprises instrument procedure information, such as instrument approach procedures, standard terminal arrival routes, instrument departure procedures, standard instrument departure routes, obstacle departure procedures, or the like, traditionally displayed on a published charts, such as Instrument Approach Procedure (IAP) charts, Standard Terminal Arrival (STAR) charts or Terminal Arrival Area (TAA) charts, Standard Instrument Departure (SID) routes, Departure Procedures (DP), terminal procedures, approach plates, and the like. In exemplary embodiments, the data storage element 118 maintains associations between prescribed operating parameters, constraints, and the like and respective navigational reference points (e.g., waypoints, positional fixes, radio ground stations (VORs, VORTACs, TACANs, and the like), distance measuring equipment, non-directional beacons, or the like) defining the aircraft procedure, such as, for example, altitude minima or maxima, minimum and/or maximum speed constraints, RTA constraints, and the like. In this regard, although the subject matter may be described in the context of a particular procedure for purpose of explanation, the subject matter is not intended to be limited to use with any particular type of aircraft procedure and may be implemented for other aircraft procedures in an equivalent manner.

Additionally, in some embodiments, the data storage element 118 may be realized as a remote database external to the aircraft 120 that is communicatively coupled to the processing system 106 over a communications network (e.g., via the communications system 110). For example, in some embodiments, the data storage element 118 may be realized as a NOTAM database, a PIREP database or another remote database or data source from which the processing system 106 may obtain notices, reports or any other sort of communiques or messages that include data or information relevant to operation of the aircraft 120. In this regard, in some embodiments, such a message database may be maintained or otherwise provided by a governmental or regulatory organization. For example, in one embodiment, the data storage element 118 may be realized as a NOTAM database maintained by the FAA in the United States. In other embodiments, the data storage element 118 may be realized as a database or other data storage associated with a third-party data service.

It should be understood that FIG. 1 is a simplified representation of the system 100 for purposes of explanation and ease of description, and FIG. 1 is not intended to limit the application or scope of the subject matter described herein in any way. It should be appreciated that although FIG. 1 shows the display device 102, the user input device 104, and the processing system 106 as being located onboard the aircraft 120 (e.g., in the cockpit), in practice, one or more of the display device 102, the user input device 104, and/or the processing system 106 may be located outside the aircraft 120 (e.g., on the ground as part of an air traffic control center or another command center) and communicatively coupled to the remaining elements of the system 100 (e.g., via a data link and/or communications system 110). Similarly, in some embodiments, the data storage element 118 may be located outside the aircraft 120 and communicatively coupled to the processing system 106 via a data link and/or communications system 110. Furthermore, practical embodiments of the system 100 and/or aircraft 120 will include numerous other devices and components for providing additional functions and features, as will be appreciated in the art. In this regard, it will be appreciated that although FIG. 1 shows a single display device 102, in practice, additional display devices may be present onboard the aircraft 120. Additionally, it should be noted that in other embodiments, features and/or functionality of processing system 106 described herein can be implemented by or otherwise integrated with the features and/or functionality provided by the FMS 114. In other words, some embodiments may integrate the processing system 106 with the FMS 114. In yet other embodiments, various aspects of the subject matter described herein may be implemented by or at an electronic flight bag (EFB) or similar electronic device that is communicatively coupled to the processing system 106 and/or the FMS 114.

FIG. 2 depicts an exemplary embodiment of a message prioritization system 200 suitable for implementation in connection with a vehicle, such as aircraft 120, to intelligently analyze and contextually prioritize messages related to vehicle operation in for improved comprehension and actionability. For purposes of explanation, the message prioritization system 200 is primarily described herein in the context of analyzing NOTAMs relevant to an aircraft's flight plan (or planned flight path), however, it will be appreciated that the subject matter described herein is not limited to NOTAMs and may be implemented in an equivalent manner for any type or sort of message or communique. Accordingly, for purposes of explanation, but without limitation, the message prioritization system 200 may alternatively be referred to herein as a NOTAM prioritization system.

In the illustrated embodiment, the NOTAM prioritization system 200 includes a processing system 208 (e.g., processing system 106) that is configurable to support a NOTAM analysis service 210 that retrieves and analyzes NOTAMs 202 from a remote system 204 using one or more AI models 214 maintained in a data storage element 212 (e.g., data storage element 118) coupled to the processing system 208. In this regard, the NOTAM analysis service 210 utilizes the AI models 214 in connection with NLP, parts of speech tagging and other language processing techniques to analyze the textual content of the NOTAMs 202 that are relevant to the planned flight path (or route) using NLP) to determine the intent, objective or semantic significance of a respective NOTAM 202 and identify specified values for different fields of information contained within a respective NOTAM 202. The processing system 208 is also communicatively coupled to one or more onboard systems 206 (e.g., one or more of the systems 108, 110, 112, 114, 116) to obtain the current values or currently planned values for different fields of information, which, in turn, are utilized by the NOTAM analysis service 210 to identify discrepancies or differences between the content of a particular NOTAM 202 and the current flight plan or current aircraft state.

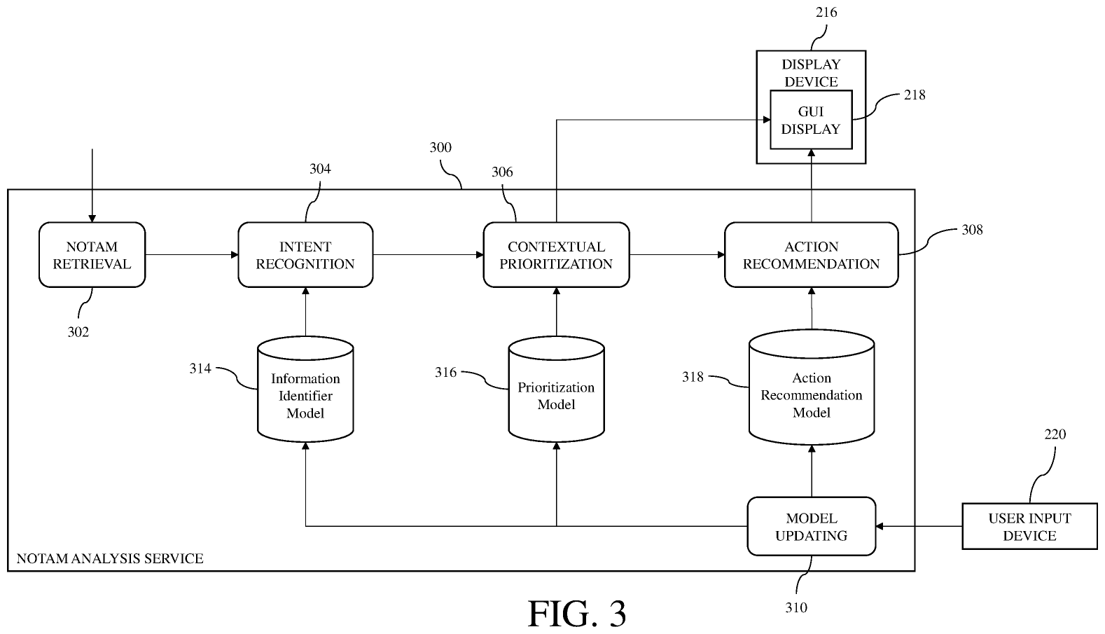

As described in greater detail below in the context of FIGS. 3-7, when a discrepancy associated with a particular NOTAM 202 is identified, the NOTAM analysis service 210 automatically assigns a priority to that NOTAM 202 based on the intent of that NOTAM 202 utilizing one or more AI models 214 and provides graphical indicia of the NOTAM-specified field value(s) and assigned priority on a GUI display 218 depicted on a display device 216 (e.g., display device 102). In this manner, a pilot or other user may more readily comprehend the relative significance of the discrepancy posed by the NOTAM 202 and more quickly identify the specified field value(s) contained within a NOTAM 202 that are different from the current values associated with the current aircraft state or the current flight plan. Additionally, the NOTAM analysis service 210 may also automatically recommend actions to be undertaken using the one or more AI models 214 based on historical pilot behavior and provide corresponding graphical indicia of the recommended action(s) on the GUI display 218. In this manner, the NOTAM analysis service 210 facilitates timely action with respect to a NOTAM of concern.

In one or more embodiments, the AI models 214 utilized by the NOTAM analysis service 210 are dynamically updated over time to adapt to pilot behaviors to improve the prioritization in a manner that better reflects the pilot(s) subjective prioritization of different NOTAMs 202, while also adapting the automated recommendations to better comport with pilot actions. For example, the GUI display 218 generated by the NOTAM analysis service 210 may include one or more GUI elements that are manipulable by a pilot or other user using the user input device 220 to perform actions with respect to different NOTAMs 202, such as, for example, reassigning a different priority to a NOTAM 202, deprioritizing a NOTAM 202, initiating (or declining to initiate) a recommended action responsive to a NOTAM 202, manually initiating an action different from a recommended action responsive to a NOTAM 202, and/or the like. In this regard, the NOTAM analysis service 210 may utilized self-learning AI techniques to dynamically update and adapt the AI models 214 to better reflect observed pilot behaviors.

Still referring to FIG. 2, depending on the embodiment, the processing system 208 may be implemented or realized with a general purpose processor, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. In practice, the processing system 208 includes processing logic that may be configured to carry out the functions, techniques, and processing tasks associated with the NOTAM analysis service 210, as described in greater detail below. In this regard, the steps of a method or algorithm described in connection with the embodiments disclosed herein may be embodied directly in hardware, in firmware, in a software module executed by the processing system 208, or in any practical combination thereof. For example, in one or more embodiments, the processing system 208 includes or otherwise accesses the data storage element 212, which may be realized as any sort of non-transitory short or long term storage media capable of storing programming instructions for execution by the processing system 208. The code or other computer-executable programming instructions, when read and executed by the processing system 208, cause the processing system 208 to generate or otherwise support the NOTAM analysis service 210 and e perform certain tasks, operations, functions, and/or processes described herein.

FIG. 3 depicts an exemplary embodiment of a message analysis service 300 suitable for use as the NOTAM analysis service 210 in FIG. 2. The NOTAM analysis service 300 includes a NOTAM retrieval service 302 that is configured to retrieve a subset of NOTAMs (e.g., from the remote system 204) that are relevant to the current flight plan. In this regard, the NOTAM retrieval service 302 may utilize the waypoints, airspaces, airports, GPS coordinates and the like associated with the flight plan and/or the current aircraft state to search or query the remote system 204 for NOTAMs 202 that are likely to be relevant to the current flight plan and effectively filter or exclude, from further consideration, any NOTAMs 202 that are not relevant to the waypoints, airspaces or other aspects of the current flight plan. After retrieving the subset of NOTAMs for analysis, the NOTAM retrieval service 302 may further preprocess the NOTAMs by expanding acronyms and translating the NOTAMs into a common uniform format to standardize the input to AI models or other downstream services that analyze the NOTAMs.

The obtained subset of NOTAMs relevant to the current flight plan are input or otherwise provided to an intent recognition service 304 that is configured to utilize NLP, parts of speech tagging or other semantic or syntactic AI techniques to analyze the textual content of a respective NOTAM to identify the different fields of information contained within the respective NOTAM, the specified values for those fields of information, and the intent, objective or semantic significance of a respective NOTAM. In this regard, for each NOTAM analyzed by the NOTAM analysis service 300, the intent recognition service 304 outputs a structured data record or entry that includes the textual content of the respective NOTAM along with the metadata tags identifying the intent assigned to the respective NOTAM and the extracted values for the different fields of information contained within the respective NOTAM. The intent recognition service 304 parses or otherwise analyzes the textual content of a NOTAM using an information identifier model 314 to extract or otherwise identify, for example, the operational subject of the NOTAM (e.g., a runway, a taxiway, a waypoint, or the like), an operational parameter value associated with the operational subject in the NOTAM (e.g., the runway identifier, taxiway identifier, waypoint identifier or the like), a status associated with the operational subject, an action associated with the NOTAM and/or other restrictions, instructions or conditions associated with the NOTAM. For example, for a NOTAM with the textual content “RWY 09/27 Closed Except 24 HR Prior Permission Required,” the intent recognition service 304 may parse and analyze the text to identify a runway as the operational subject of the NOTAM, identify runway identifier 09/27 as the specified value for the runway field, identify the runway status as closed, identify permission required within 24 hours of using the runway as a condition associated with the runway, and determine the intent of the NOTAM to notify a pilot of the requirement to obtain clearance from air traffic control (ATC) within 24 hours prior to using the runway. In one or more embodiments, the intent recognition service 304 is implemented or realized using language generation or a generative model. In this regard, in one implementation, the information identifier model 314 is trained using an offline or previously-collected training data set before being deployed using language generation or a generative model, and then after deployment, meta learning or few-shot learning is utilized to adaptively update the intent recognition service 304 and/or the information identifier model 314 in response to user input actions to provide user-specific performance.

Still referring to FIG. 3, the NOTAM analysis service 300 includes a contextual prioritization service 306 that is configured to automatically classify or otherwise assign a particular priority level or priority score to NOTAMs based on the extracted metadata values assigned to the NOTAM by the intent recognition service 304 using data or information characterizing the current operational context of the aircraft and a prioritization model 316. In this regard, the contextual prioritization service 306 retrieves or otherwise obtains, from one or more data sources (e.g., onboard systems 206), the instantaneous, real-time or most recent available values for one or more parameters that quantify the current operation (or currently planned operation) of the aircraft. For example, the NOTAM analysis service 300 may obtain (e.g., from FMS 114, navigation system 112 and/or other avionic systems 116) one or more of the following: the current location of the aircraft, the current altitude (or above ground level) of the aircraft, the current heading (or bearing) of the aircraft, the current amount of fuel remaining onboard the aircraft 120, the current engine status, the current aircraft configuration (e.g., the current flap configuration, the current landing gear configuration, and/or the like), the current flight phase and/or the like in addition to the current flight plan associated with the aircraft. Additionally, the NOTAM analysis service 300 may obtain information indicative of different external conditions along the planned flight path (or route) that could influence operation of the aircraft, such as, for example, the current, forecasted and/or anticipated meteorological conditions at or near the current location of the aircraft (e.g., the current temperature, wind speed, wind direction, atmospheric pressure, turbulence, and the like) as well as at various geographic locations and/or altitudes along the flight plan route. Additionally, the NOTAM analysis service 300 may obtain information indicative of the current or anticipated air traffic, airspace restrictions, or other conditions along the flight plan route.

In one or more embodiments, the contextual prioritization service 306 automatically classifies and assigns each NOTAM received from the intent recognition service 304 to one of a high priority level (e.g., “Attention”), an intermediate priority level (e.g., “Caution”) and a low priority level (e.g., “Notice”) based on the current operational context, the intent of the NOTAM, the particular field(s) of information where the discrepancy or difference between the specified value(s) in the NOTAM and the current value(s), the magnitude or nature of the discrepancy or difference and the current flight plan using the NOTAM prioritization model 316. For example, the contextual prioritization service 306 may be implemented or realized using a neural network, such as a transformer neural network, that utilizes the NOTAM prioritization model 316 to classify and assign an input NOTAM to a particular priority level based on the structured metadata associated with the NOTAM and the current operational context. In this regard, similar to the intent recognition service 304 and/or the information identifier model 314, the contextual prioritization service 306 and/or the NOTAM prioritization model 316 is initially trained using language generation or a generative model and then adaptively updated using meta learning or few-shot learning responsive to subsequent user input actions.

Still referring to FIG. 3, in exemplary embodiments, the NOTAM analysis service 300 includes an action recommendation service 308 that is configured to automatically determine and recommend actions to be undertaken by a pilot or other user responsive to a NOTAM message that is assigned a priority level that indicates a response is likely to be necessary or desired. In this regard, the action recommendation service 308 utilizes an action recommendation model 318 in connection with one or more AI techniques to automatically determine one or more recommended actions based on historical pilot behavior using the intent associated with the NOTAM message, the priority level assigned to the NOTAM message, the particular field(s) of information where the discrepancy or difference between the specified value(s) in the NOTAM and the current value(s), the magnitude or nature of the discrepancy or difference and the current flight plan and/or the like. In this regard, the action recommendation service 308 and/or the action recommendation model 318 may be initially trained using language generation or a generative model, that may be subsequently retrained or updated using language generation or a generative model that accounts for subsequent user input actions.

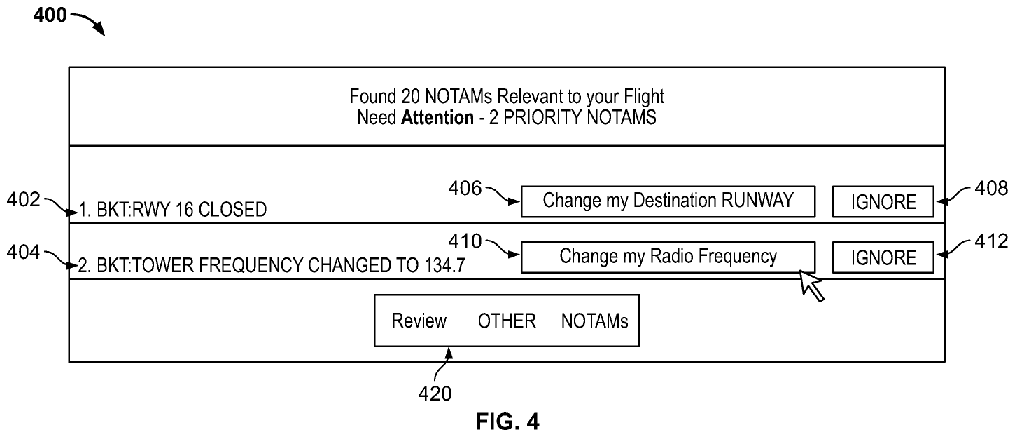

Referring now to FIGS. 4-7, with continued reference to FIGS. 2-3, in exemplary embodiments, the NOTAM analysis service 210, 300 is configured to generate one or more GUI displays 218 on a display device 216 that include graphical indicia of the automatically-assigned priority level associated with at least a subset of the relevant NOTAMs 202, the discrepancies or differences associated with those NOTAMs 202, and the automatically-generated recommended actions to be undertaken responsive to those NOTAMs 202. FIG. 4 depicts an exemplary prioritized NOTAM GUI display 400 that includes graphical representations of the NOTAMs 402, 404 that were assigned to the highest priority level (e.g., “Attention”). The graphical representations of the NOTAMs 402, 404 indicate the specified field values within the respective NOTAM 402, 404 that were responsible for the discrepancy that influenced the classification of the respective NOTAM 402, 404 to the attention priority level, such as, for example, the “closed” value for the status of runway 16 in the first NOTAM 402 and the tower frequency value of “134.7” for the second NOTAM 404. In this regard, in one or more exemplary embodiments, the graphical representations of the NOTAMs 402, 404 are generated using the structured metadata and extracted intent of the respective NOTAM 402, 404 to arrive at a filtered or augmented version of the respective NOTAM 402, 404 that only includes the specified values for the different fields or parameters contained within the respective NOTAM 402, 404 that convey the intent of the respective NOTAM 402, 404 by excluding content that is not relevant to the intent of the respective NOTAM 402, 404 or the discrepancy associated with the respective NOTAM 402, 404.

Still referring to FIG. 4, in exemplary embodiments, the prioritized NOTAM GUI display 400 includes a list of entries associated with each NOTAM 402, 404 assigned to the attention priority level, where the entry associated with a respective NOTAM 402, 404 includes a graphical representation of the content of the respective NOTAM 402, 404 and a selectable GUI element 406, 410 associated with the recommended action determined for the respective NOTAM 402, 404 by the action recommendation service 308. For example, for the depicted NOTAM 402 indicating the status for runway 16 is closed, when the current flight plan designates runway 16 as the destination runway, the action recommendation service 308 may automatically determine the recommended action responsive to the NOTAM 402 as changing the destination runway associated with the flight plan and render a corresponding GUI element 406 that is selectable by the pilot or other user to initiate changing the destination runway directly from the prioritized NOTAM GUI display 400. For the depicted NOTAM 404 indicating the tower frequency is changed, when the current value for the frequency setting of the communications radio is different from the value specified in the NOTAM 404, the action recommendation service 308 may automatically determine the recommended action responsive to the NOTAM 404 as changing the communications radio frequency to the value specified by the NOTAM 404 and render a corresponding GUI element 410 that is selectable by the pilot or other user to initiate changing the communications radio frequency directly from the prioritized NOTAM GUI display 400. As another example, the action recommendation service 308 may automatically determine the recommended action responsive to the NOTAM 402 as reviewing or briefing an aviation chart associated with the runway, where selection of the GUI element to review the chart results in a graphical representation of the aviation chart being rendered on the display device 216 with the specified frequency setting being highlighted or otherwise graphically emphasized on the depicted chart. Still referring to FIG. 4, in exemplary embodiments, the NOTAM GUI display 400 also includes selectable GUI elements 408, 412 that allow the pilot or other user to override the priority level assigned to a respective NOTAM 402, 404 and decline, disregard or otherwise ignore the recommended actions.

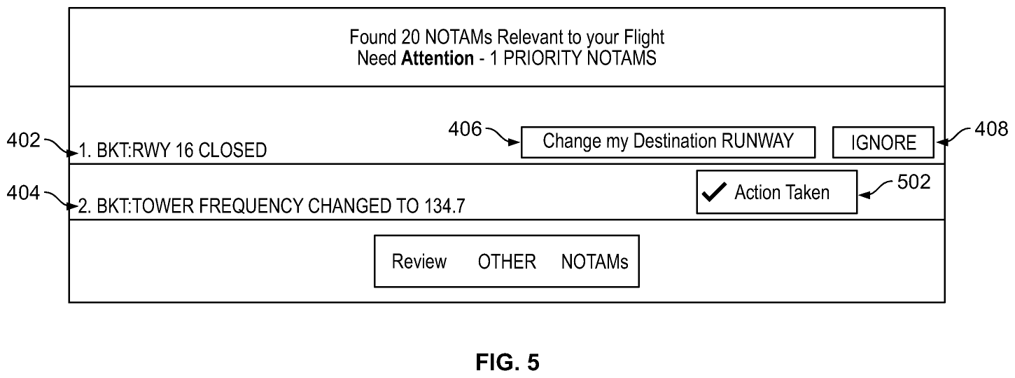

FIG. 5 depicts an updated state 500 of the prioritized NOTAM GUI display 400 of FIG. 4 in response to user selection of the button 410 to change the communications radio frequency from the current frequency value to the specified value of 134.7 designated by the NOTAM 404. In this regard, in response to selection of the button 410, the NOTAM analysis service 210, 300 commands, signals or otherwise instructs the communications system 110 or another onboard system 206 to change the value for the radio frequency setting from the current value to the value of 134.7 specified by the NOTAM 404. Additionally, the NOTAM analysis service 210, 300 updates the NOTAM GUI display 400 to include a graphical indication 502 that action has been taken responsive to the NOTAM 404, thereby facilitating a pilot or other user using the updated NOTAM GUI display 500 to monitor or track which prioritized NOTAMs have been addressed and identify the prioritized NOTAMs that still require attention. The NOTAM analysis service 210, 300 may also render the graphical representation of the NOTAM 404 using a different visually distinguishable characteristic (e.g., a visually distinguishable color, font, shading, fading, transparency, or the like) on the updated NOTAM GUI display 500 to indicate the NOTAM 404 no longer requires a response. In other embodiments, rather than providing graphical indicia that the NOTAM 404 has been responded to, in alternative embodiments, the NOTAM analysis service 210, 300 updates the NOTAM GUI display 400 by removing the entry associated with the NOTAM 404 from the list of NOTAMs, such that the NOTAM GUI display 400 only retains those NOTAMs that have yet to be acted upon.

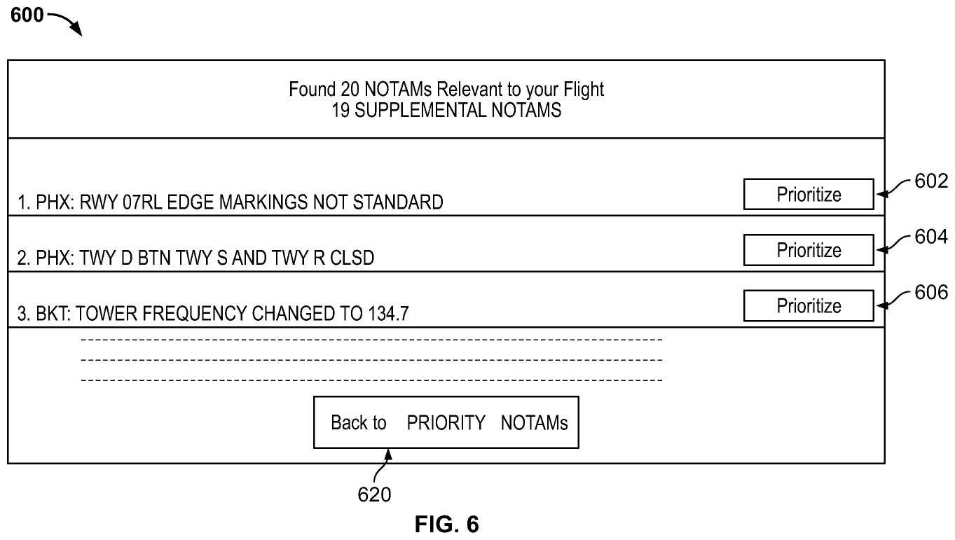

Referring to FIG. 6 with reference to FIG. 4, in exemplary embodiments, the NOTAM analysis service 210, 300 is also configured to generate a NOTAM GUI display 600 that includes NOTAMS that assigned to lower priority levels separately from the prioritized GUI display 400 along with selectable GUI elements 420, 620 on the respective GUI displays 400, 600 that allow the pilot or other user to toggle between GUI displays 400, 600 to selectively view listings of different subsets of NOTAMs assigned to different priority levels. In this regard, FIG. 6 depicts a supplemental NOTAM GUI display 600 that includes a listing with the graphical representation of NOTAMs assigned to the lower priority levels (e.g., “Caution” or “Notice”) for a scenario where the pilot or other user selects the button 412 associated with the NOTAM 404 to ignore and manually reassign the NOTAM 404 to a lower priority level. In this regard, in response to selection of the button 412 to deprioritize the NOTAM 404, in some embodiments, the NOTAM analysis service 210, 300 may dynamically update the priority field of the structured metadata associated with the NOTAM 404 to reflect the lower priority level that was manually assigned to the NOTAM 404 in lieu of the originally assigned priority value (e.g., by changing the value of the priority field from “Attention” to “Notice”). The supplemental NOTAM GUI display 600 similarly includes selectable GUI elements 602, 604, 606 that are selectable by a pilot or other user to manually reassign a respective NOTAM from the lower priority level to a higher priority level. In one or more embodiments, in response to selection of a button 602, 604, 606, the NOTAM analysis service 210, 300 may dynamically update the priority field of the structured metadata associated with the respective NOTAM to reflect the higher priority level (e.g., “Attention”) that was manually assigned to the respective NOTAM. Additionally, in one or more embodiments, selection of a button 602, 604, 606 to prioritize a NOTAM may trigger or otherwise initiate the action recommendation service 308 analyzing the respective NOTAM to determine a recommended action to be utilized to populate the selectable GUI element(s) for the entry associated with the NOTAM on the prioritized NOTAM GUI display.

Referring again to FIG. 3 with reference to FIGS. 4-6, in one or more embodiments, the NOTAM analysis service 210, 300 includes or otherwise supports a model updating service 310 that is capable of dynamically updating the AI models 314, 316, 318 in response to user selections or other user input received with respect to the GUI displays 218, 400, 500, 600 generated by NOTAM analysis service 210, 300 via the user input device 220. For example, when a pilot manually reassigns a different priority level to a respective NOTAM, the model updating service 310 may dynamically and adaptively update the prioritization model 316 to better comport with the observed pilot behavior. On the other hand, when the pilot manually selects, accepts or otherwise initiates an autogenerated recommended action, the model updating service 310 may dynamically update the prioritization model 316 and/or the action recommendation model 318 to increase the confidence associated with the prioritization and/or recommendation for subsequent operation. Conversely, when a pilot manually reassigns a different priority level to a respective NOTAM, the model updating service 310 may dynamically and adaptively update the prioritization model 316 to better reflect the pilot's subjective prioritization of NOTAMs. Likewise, when a pilot manually initiates a different action responsive to a respective NOTAM, the model updating service 310 may dynamically and adaptively update the action recommendation model 318 to better align with observed pilot behavior. As described above, the model updating service 310 may utilize meta learning or few-shot generalization to augment the AI models 314, 316, 318 in a user-specific manner at run-time or substantially in real-time, for example, by creating a cached user-specific model that can be utilized independently and/or in concert with a static initial model.

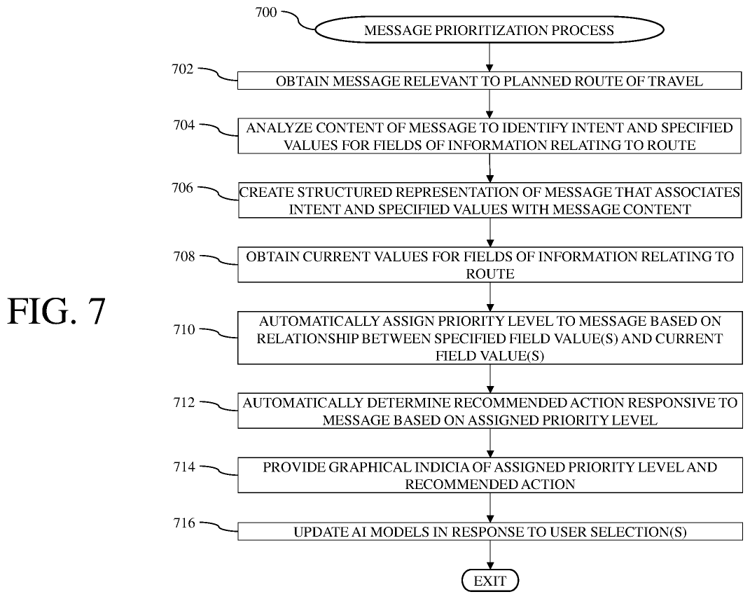

FIG. 7 depicts an exemplary embodiment of a message prioritization process 700 suitable for implementation in connection with a vehicle system to intelligently prioritize messages related to vehicle operation in a manner that is influenced by the current operational context and reflects historical user behavior with respect to prior messages. The various tasks performed in connection with the message prioritization process 700 may be implemented using hardware, firmware, software executed by processing circuitry, or any combination thereof. For illustrative purposes, the following description may refer to elements mentioned above in connection with FIGS. 1-3. In practice, portions of the message prioritization process 700 may be performed by different elements of the systems 100, 200; however, for purposes of explanation, the message prioritization process 700 may be described herein primarily in the context of being implemented by the NOTAM analysis service 210, 300 executed by a processing system 106, 208 and using the AI models 214, 314, 316, 318 maintained at a data storage element 118, 212. It should be appreciated that the message prioritization process 700 may include any number of additional or alternative tasks, the tasks need not be performed in the illustrated order and/or the tasks may be performed concurrently, and/or the message prioritization process 700 may be incorporated into a more comprehensive procedure or process having additional functionality not described in detail herein. Moreover, one or more of the tasks shown and described in the context of FIG. 7 could be omitted from a practical embodiment of the message prioritization process 700 as long as the intended overall functionality remains intact.

Referring to FIG. 7 with continued reference to FIGS. 1-6, the message prioritization process 700 receives, retrieves or otherwise obtains one or more messages relevant to a planned route of travel for a vehicle (task 702). As described above, a NOTAM retrieval service 302 associated with the NOTAM analysis service 210, 300 may utilize the current flight plan or other current contextual information related to the current status of the aircraft 120 obtained from one or more onboard systems 108, 110, 112, 114, 116, 206 to selectively retrieve, from a remote system 204 or other external data source, a subset of the NOTAMs 202 that are relevant to the current flight plan. In this regard, by converting NOTAMs 202 into a structured format, current values from the flight plan or other onboard systems may be utilized as one or more search keys and/or filter criteria to filter or otherwise exclude, from consideration, any NOTAMs 202 that are unrelated to the current flight plan or current aircraft state and retrieve only the subset of NOTAMs 202 that relate to the airports, waypoints, airspaces or other geographic regions associated with the current flight plan.

For a message relevant to the planned route of travel, the message prioritization process 700 analyzes the textual content of the respective message to extract or otherwise identify the intent of the message and specified values for fields of information relating to vehicle operation along the route and generates or otherwise creates a structured representation of the message that maintains an association between the textual content of the message, the intent associated with the message, and the specified field values extracted from the message (tasks 704, 706). In this regard, as described above, the intent recognition service 304 associated with the NOTAM analysis service 210, 300 may parse or otherwise analyze the textual content of a NOTAM 202 using NLP techniques and/or AI techniques using the information identifier model 314 to identify what the intent or objective associated with the NOTAM 202 is while also identifying the specified values for various operational subjects or parameters referenced by the textual content of the NOTAM 202. For example, for a NOTAM 202 with the textual content of “RWY 09/27 Closed Except 24 HR Prior Permission Required,” the intent recognition service 304 may determine the intent of the NOTAM to notify a pilot of the requirement to obtain clearance from air traffic control (ATC) within 24 hours prior to attempting to use a runway, identify runway identifier 09/27 as the specified value for the runway field and identify the runway status as closed. Thereafter, the intent recognition service 304 may create a data structure that provides a structured representation of the NOTAM 202 that maintains extracted specified field values and the determined intent associated with the NOTAM 202 as fields of metadata associated with the textual content and other identifying information associated with the NOTAM 202 (e.g., the source of the NOTAM, the timestamp of the NOTAM, and/or the like). For example, if a NOTAM 202 includes a condition, a condition field of the data structure that provides a structured representation may be populated with a specified value that was identified within and extracted from the NOTAM 202 by the intent recognition service 304.

After analyzing the content of a message to identify its intent and extract specified field values, the message prioritization process 700 continues by receiving, retrieving or otherwise obtaining current values for the fields of information relating to vehicle operation along the route of travel from one or more data sources associated with the vehicle and automatically assigns a priority level to the message based on the relationship between one or more of the current values and the specified values associated with the message (tasks 708, 710). For example, as described above, the contextual prioritization service 306 of the NOTAM analysis service 210, 300 may retrieve current values that characterize the current aircraft status and the current flight plan from the FMS 114 or other onboard systems 108, 110, 112, 116, 206 and analyze the current values to identify any differences or discrepancies between a current value for a parameter or field related to the current (or currently planned) operation of the aircraft 120 and a specified value for that parameter or field associated with the NOTAM 202. When the contextual prioritization service 306 identifies a discrepancy between one or more of the specified value(s) for an operational subject or an operational parameter derived from the NOTAM 202 and the corresponding current value(s) for that operational subject or operational parameter maintained at one or more onboard systems 108, 110, 112, 114, 116, 206, the contextual prioritization service 306 automatically assigns a priority level to the NOTAM 202 that is influenced by the discrepancy and the intent of the NOTAM 202.

In one or more exemplary embodiments, the contextual prioritization service 306 utilizes the prioritization AI model 316 to determine the priority level to be assigned to the NOTAM 202 as a function of the intent associated with the NOTAM 202, the discrepancy or difference between specified field value(s) from the NOTAM 202 and the current field value(s) at the onboard systems 108, 110, 112, 114, 116, 206 and/or other current values characterizing the current operational context associated with the aircraft 120. For example, the current values characterizing the current operational context associated with the aircraft 120 and the intent associated with the NOTAM 202 may be provided as input variables to the prioritization AI model 316 along with indicia of the discrepancy or difference between specified field value(s) from the NOTAM 202 and the current field value(s), which, in turn results in the contextual prioritization service 306 classifying the NOTAM 202 into a particular priority level using the prioritization AI model 316. As described above, the prioritization AI model 316 may be trained or developed in a manner that reflects historical pilot behaviors for different combinations of NOTAMs and corresponding aircraft operational contexts. Thus, NOTAMs that are consistent with or otherwise conform to the current state of operation or current flight plan may be assigned to a relatively lower priority level, while NOTAMs that are divergent or inconsistent with the current state of operation or current flight plan may be assigned to a relatively higher priority level based on historical pilot behaviors.

Still referring to FIG. 7, in exemplary embodiments, the message prioritization process 700 continues by automatically determining one or more recommended actions responsive to the message based on the assigned priority level (task 712). In this regard, for lower priority levels, the NOTAM analysis service 210, 300 may determine that no response or action is required, or otherwise determine that the NOTAM should be ignored or hidden from presentation. On the other hand, for a NOTAM 202 assigned to a higher priority level, the action recommendation service 308 of the NOTAM analysis service 210, 300 automatically determines one or more recommended actions consistent with historical pilot behavior given the assigned priority level, the intent of the NOTAM 202, the current operational context, the discrepancy or difference between specified field value(s) from the NOTAM 202 and the current field value(s) and/or the like. For example, as described above, the assigned priority level, the intent of the NOTAM 202, the current values characterizing the current operational context associated with the aircraft 120, and indication of the discrepancy or difference between the specified field value(s) from the NOTAM 202 and the current field value(s) may be provided as input variables to the action recommendation AI model 318, which, in turn results in the action recommendation service 308 generating a recommended action that is consistent with historical pilot behavior in similar operational contexts (e.g., by training the action recommendation AI model 318 in a manner that reflects historical pilot behaviors).

After automatically assigning a priority level and automatically determining a recommended action, the message prioritization process 700 generates or otherwise provides graphical indicia of the automatically assigned priority level and autogenerated recommended action responsive to the message (task 714). For example, as described above in the context of FIGS. 4-6, in exemplary embodiments, the NOTAM analysis service 210, 300 renders, generates or otherwise provides a NOTAM GUI display that includes a listing of NOTAMs 202 in accordance with their assigned priority level, for example, by providing a listing of only those NOTAMs 202 relevant to the current flight plan that were assigned to a given priority level. In this regard, the NOTAM analysis service 210, 300 may automatically generate a prioritized NOTAM GUI display 400 that only includes graphical indicia of the NOTAMs 202 assigned to the highest priority level that are likely to commend themselves to the attention of the pilot or other user. In such embodiments, the graphical indicia of the NOTAM 202 includes a graphical representation of the portion of the NOTAM 202 that conveys the intent of the NOTAM 202 and includes or otherwise indicates the specified value(s) that deviate from the current value(s) associated with the current aircraft state or the current flight plan along with graphical indication of the autogenerated recommended action for responding to the respective NOTAM 202. For example, as described above, the autogenerated recommended action may be conveyed by the NOTAM analysis service 210, 300 generating a selectable GUI element that includes a text label that indicates the recommended action and, when selected, allows the pilot or other user to initiate the autogenerated recommended action directly from the prioritized NOTAM GUI display 400.

Referring again to FIG. 7, in exemplary embodiments, the message prioritization process 700 is configurable to dynamically update or retrain AI models utilized by the message prioritization process 700 in response to receiving one or more user selections (task 716). In this regard, when the pilot or other user manipulates the user input device 220 to initiate an autogenerated recommended action for a NOTAM 202, manually reassign a different priority level to the NOTAM 202, or perform some alternative action or response to the NOTAM 202, a model updating service 310 associated with the NOTAM analysis service 210, 300 captures user input data or otherwise receives information indicative of the user selections or actions that were manually initiated with respect to a particular NOTAM 202, thereby allowing the model updating service 310 to dynamically update the AI models 214, 314, 316, 318 by using the structured metadata associated with the NOTAM 202 and the corresponding user selections as training data for the AI models 214, 314, 316, 318. In this manner, the AI models 214, 314, 316, 318 may adapt over time to better reflect pilot behavior to improve the performance or quality of the AI models 214, 314, 316, 318.

For the sake of brevity, conventional techniques related to user interfaces, avionics systems, NOTAMs, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method of assisting operation of a vehicle, the method comprising:
obtaining a message relevant to a route for the vehicle;
analyzing textual content of the message to automatically identify values for a plurality of fields of information;
obtaining current values for one or more fields of the plurality of fields from one or more data sources associated with the vehicle; and
in response to identifying a difference between at least one of the values for the one or more fields of the plurality of fields and at least one of the current values for the one or more fields of the plurality of fields:
automatically assigning a priority level to the message based at least in part on the difference; and
providing graphical indicia of the priority level assigned to the message and the at least one of the values for the plurality of fields.

2. The method of claim 1, wherein the graphical indicia includes a graphical user interface (GUI) element selectable to update the at least one of the current values at the one or more data sources to the at least one of the values for the plurality of fields identified from the textual content of the message.

3. The method of claim 2, wherein:
the vehicle comprises an aircraft;
the message comprises a notice to airmen (NOTAM);
the route comprises a flight plan;
the one or more data sources comprises an avionics system onboard the aircraft; and
selection of the GUI element updates the at least one of the current values at the avionics system to the at least one of the values for the plurality of fields identified from the textual content of the NOTAM.

4. The method of claim 1, wherein automatically assigning the priority level to the message based at least in part on the difference comprises utilizing an artificial intelligence (AI) model to determine the priority level based at least in part on a subset of one or more fields of the plurality of fields exhibiting the difference.

5. The method of claim 1, wherein automatically assigning the priority level to the message based at least in part on the difference comprises utilizing an artificial intelligence (AI) model to determine the priority level based at least in part on the difference between the at least one of the values and the at least one of the current values.

6. The method of claim 1, further comprising automatically determining a recommended action responsive to the difference based on at least one of the priority level assigned to the message and the difference.

7. The method of claim 6, wherein automatically determining the recommended action comprises utilizing an artificial intelligence (AI) model to identify a historical behavior corresponding to the difference between at least one of the values for the plurality of fields and the at least one of the current values for the one or more fields of the plurality of fields.

8. The method of claim 1, wherein:
obtaining the current values comprises obtaining a current value for an operational subject associated with a current flight plan from an onboard system; and
the difference comprises a discrepancy between the current value for the operational subject associated with the current flight plan and a specified value for the operational subject contained within the textual content of the message.

9. The method of claim 1, wherein:
obtaining the current values comprises obtaining a current value for a setting of an onboard system; and
the difference comprises a discrepancy between the current value for the setting of the onboard system and a specified value contained within the textual content of the message.

10. The method of claim 1, further comprising analyzing the textual content of the message to identify an intent associated with the message, wherein automatically assigning the priority level comprises automatically assigning the priority level to the message based at least in part on the intent associated with the message.

11. The method of claim 1, wherein analyzing textual content of the message to automatically identify the values for the plurality of fields of information comprises performing natural language processing (NLP) on the textual content of the message to identify the values for the plurality of fields of information defined within the textual content of the message.

12. A computer-readable medium having computer-executable instructions stored thereon that, when executed by a processing system, cause the processing system to:
obtain a message relevant to a route for a vehicle;
analyze textual content of the message to automatically identify values for a plurality of fields of information;
obtain current values for one or more fields of the plurality of fields from one or more data sources associated with the vehicle; and
in response to a difference between at least one of the values for the one or more fields of the plurality of fields and at least one of the current values for the one or more fields of the plurality of fields:
automatically assign a priority level to the message based at least in part on the difference; and
provide graphical indicia of the priority level assigned to the message and the at least one of the values for the plurality of fields.

13. The computer-readable medium of claim 12, wherein the graphical indicia includes a graphical user interface (GUI) element selectable to update the at least one of the current values at the one or more data sources to the at least one of the values for the plurality of fields identified from the textual content of the message.

14. The computer-readable medium of claim 13, wherein:
the vehicle comprises an aircraft;
the message comprises a notice to airmen (NOTAM);
the route comprises a flight plan;
the one or more data sources comprises an avionics system onboard the aircraft; and
selection of the GUI element updates the at least one of the current values at the avionics system to the at least one of the values for the plurality of fields identified from the textual content of the NOTAM.

15. The computer-readable medium of claim 12, wherein the computer-executable instructions cause the processing system to utilize an artificial intelligence (AI) model to determine the priority level based at least in part on a subset of one or more fields of the plurality of fields exhibiting the difference.

16. The computer-readable medium of claim 12, wherein the computer-executable instructions cause the processing system to analyze the textual content of the message to identify an intent associated with the message and utilize an artificial intelligence (AI) model to determine the priority level based at least in part on a subset of one or more fields of the plurality of fields exhibiting the difference and the intent associated with the message.

17. The computer-readable medium of claim 12, wherein the computer-executable instructions cause the processing system to automatically determine a recommended action responsive to the difference based on at least one of the priority level assigned to the message, the difference and an intent associated with the message.

18. The computer-readable medium of claim 17, wherein the computer-executable instructions cause the processing system to utilize an artificial intelligence (AI) model to identify the recommended action as a historical behavior responsive to the difference between at least one of the values for the plurality of fields and the at least one of the current values for the one or more fields of the plurality of fields.

19. A system comprising:
a display device;
an onboard system to provide a current value for a field of information relating to a route for a vehicle;
a data storage element to maintain a prioritization model; and
a processing system coupled to the display device, the onboard system and the data storage element to:
obtain a message relevant to the route for the vehicle;
analyze textual content of the message to automatically identify a specified value for the field of information; and
in response to a difference between the current value and the specified value:
automatically assign a priority level to the message based at least in part on the difference using the prioritization model; and
provide graphical indicia of the priority level assigned to the message and the specified value on the display device.

20. The system of claim 19, wherein:
the vehicle comprises an aircraft;
the message comprises a notice to airmen (NOTAM);
the route comprises a flight plan;
the onboard system comprises an avionics system onboard the aircraft; and
the graphical indicia includes a selectable graphical user interface (GUI) element to update the current value for the field of information at the avionics system to the specified value.
